(19) United States
(12) Patent Application Publication
(10) Pub. No.: US 2017/0201566 A1
(43) Pub. Date: Jul. 13, 2017

(54) FILE DOWNLOADING METHOD, APPARATUS, AND TERMINAL DEVICE

(71) Applicant: GUANGZHOU UC NETWORK TECHNOLOGY CO., LTD., Guangzhou (CN)

(72) Inventor: Zhiyi ZHANG, Guangzhou (CN)

(21) Appl. No.: 15/398,939

(22) Filed: Jan. 5, 2017

(30) Foreign Application Priority Data
Jan. 8, 2016 (CN) 201610015559.0

(51) Int. Cl. H04L 29/08; H04W 4/18

(52) U.S. Cl. CPC H04L 67/06; H04W 4/18

(57) ABSTRACT

In accordance with various embodiments of the present disclosure, a file downloading method, a related apparatus, and a related terminal device are provided. In some embodiments, the method comprises: based on target file information of a target file, starting a plurality of segment-download threads to download a plurality of segment files of the target file; when one of the plurality of segment-download threads has completed its download task, identifying a segment-download thread as a to-be-assisted segment-download thread, which still has un-downloaded content; cutting a tail portion of the un-downloaded content corresponding to the to-be-assisted segment-download thread according to a predetermined proportion; and starting the one segment-download thread that has completed its download task again to download the tail portion of the un-downloaded content corresponding to the to-be-assisted segment-download thread.

### CROSS-REFERENCES TO RELATED APPLICATIONS

This application claims the priority of Chinese Patent Application No. 201610015559.0, filed on Jan. 8, 2016, the entire content of which is incorporated herein by reference.

### FIELD OF THE DISCLOSURE

The present disclosure generally relates to the field of computer mobile communication technology and, more particularly relates to a file downloading method, a related apparatus and related terminal device.

### BACKGROUND

When using the multi-thread technique to download a target file through a network, the target file can be divided into multiple file segments to be downloaded by multiple threads respectively. The multiple file segments can be downloaded separately, and then be assembled as a complete file.

However, due to the uncertainty of the multi-thread scheduling of the system, when the multiple download threads respectively download the corresponding file segments, it cannot be guaranteed that the download tasks of the multiple download threads can be simultaneously completed.

In the cases of poor network conditions, the time points of completing a number of download tasks may be notably different. Especially for the mobile terminal devices that have relatively poor CPU performances, sometimes, a download thread has not even begun to download, yet another download thread may has completed its download task. Therefore, in such poor network conditions or low equipment performance situations, the download speed can be generally very slow.

The disclosed method and apparatus are directed to solve one or more problems set forth above and other problems.

### BRIEF SUMMARY OF THE DISCLOSURE

In accordance with some embodiments of the present disclosure, a file downloading method, a related apparatus, and a related terminal device are provided.

An aspect of the present disclosure provides a method for downloading files, comprising: based on target file information of a target file, starting a plurality of segment-download threads to download a plurality of segment files of the target file; when one of the plurality of segment-download threads has completed its download task, identifying a segment-download thread as a to-be-assisted segment-download thread, which still has un-downloaded content; cutting a tail portion of the un-downloaded content corresponding to the to-be-assisted segment-download thread according to a predetermined proportion; and starting the one segment-download thread that has completed its download task again to download the tail portion of the un-downloaded content corresponding to the to-be-assisted segment-download thread.

In some embodiments, the to-be-assisted segment-download thread is identified as one of the plurality of segment-download threads that has a largest sized un-downloaded content.

In some embodiments, the to-be-assisted segment-download thread is identified as one of the plurality of segment-download threads that has a longest expected remaining download time.

In some embodiments, based on target file information of the target file, starting the plurality of segment-download threads to download the plurality of segment files of the target file includes: obtaining a file size of the target file based on the target file information; performing a segmentation process to the target file to obtain the plurality of segment files of the target file; allocating the plurality of segment-download threads based on a total number of the plurality of segment files; and starting the plurality of segment-download threads to download the plurality of segment files of the target file respectively.

In some embodiments, before cutting the tail portion of the un-downloaded content, the method further comprises: determining whether a data amount of the un-downloaded content corresponding to the to-be-assisted segment-download thread is less than a preset threshold value; when it is determined that the data amount of the un-downloaded content is less than the preset threshold value, using the to-be-assisted segment-download thread to directly download the un-downloaded content; and when it is determined that the data amount of the un-downloaded content is not less than the preset threshold value, cutting the tail portion of the un-downloaded content corresponding to the to-be-assisted segment-download thread according to the predetermined proportion.

In some embodiments, the method further comprises: monitoring download status of the plurality of segment-download threads and size changes of un-downloaded portions of the plurality of segment files during downloading process; determining whether a segment-download thread has completed its download task; when it is determined that one segment-download thread has completed its download task, determining whether all segment-download threads have completed their download tasks; when it is determined that not all segment-download threads have completed their download tasks, identifying one segment-download thread as the to-be-assisted segment-download thread; and when it is determined that that no segment-download thread has completed its download task, continually monitoring the download status of the plurality of segment-download threads and the size changes of un-downloaded portions of the plurality of segment files during downloading process.

In some embodiments, cutting the tail portion of the un-downloaded content corresponding to the to-be-assisted segment-download thread according to the predetermined proportion includes: cutting the un-downloaded content corresponding to the to-be-assisted segment-download thread into a head portion and the tail portion according to a dichotomy method; and assigning the tail portion of the un-downloaded content to the segment-download thread that has completed its download task.

In some embodiments, the segmentation process equally divided the target file into the plurality of segment files of the target file.

In some embodiments, a total number of the plurality of segment files of the target file is less or equal to a predetermined threshold; and the predetermined threshold is set by a user for limiting a number of the plurality of segment-download threads.

In some embodiments, after cutting the tail portion of the un-downloaded content, the method further comprises: adding a new segment file record to a file downloading data table corresponding to the target file.

Another aspect of the present disclosure provides an apparatus for downloading files, comprising: a first starting module configured for, based on target file information, starting a plurality of segment-download threads to download a plurality of segment files of a target file; an obtaining module configured for, when one of the plurality of segment-download threads has completed its download task, identifying a segment-download thread as a to-be-assisted segment-download thread, which still has un-downloaded content; a cutting module configured for cutting a tail portion of the un-downloaded content corresponding to the to-be-assisted segment-download thread according to a predetermined proportion; and a second starting module configured for starting the one segment-download thread that has completed its download task again to download the tail portion of the un-downloaded content corresponding to the to-be-assisted segment-download thread.

In some embodiments, the to-be-assisted segment-download thread is identified as one of plurality of segment-download threads that has a largest sized un-downloaded content.

In some embodiments, the to-be-assisted segment-download thread is identified as one of plurality of segment-download threads that has a longest expected remaining download time.

In some embodiments, the first starting module includes: an information obtaining unit configured for obtaining a file size of the target file based on the target file information; a segmentation processing unit configured for performing a segmentation process to the target file to obtain the plurality of segment files of the target file; a threads allocating unit configured for allocating the plurality of segment-download threads based on a number of the plurality of segment files; and a threads staring unit configured for starting the plurality of segment-download threads to download the plurality of segment files of the target file respectively.

In some embodiments, the apparatus further comprises: a determining module configured for: determining whether a data amount of the un-downloaded content corresponding to the to-be-assisted segment-download thread is less than a preset threshold value, when it is determined that the data amount of the un-downloaded content is less than the preset threshold value, controlling the to-be-assisted segment-download thread to directly download the un-downloaded content, and when it is determined that the data amount of the un-downloaded content is not less than the preset threshold value, controlling the cutting module to cut the tail portion of the un-downloaded content corresponding to the to-be-assisted segment-download thread according to the predetermined proportion.

In some embodiments, the obtaining module is further configured for: monitor download status of the plurality of segment-download threads and size changes of un-downloaded portions of the plurality of segment files during downloading process; determining whether a segment-download thread has completed its download task; when it is determined that one segment-download thread has completed its download task, determining whether all segment-download threads have completed their download tasks; when it is determined that not all segment-download threads have completed their download tasks, identifying one segment-download thread as the to-be-assisted segment-download thread; and when it is determined that no segment-download thread has completed its download task, continually monitoring the download status of the plurality of segment-download threads and the size changes of un-downloaded portions of the plurality of segment files during downloading process.

In some embodiments, the cutting module is further configured for: cutting the un-downloaded content corresponding to the to-be-assisted segment-download thread into a head portion and the tail portion according to a dichotomy method; and assigning the tail portion of the un-downloaded content to the segment-download thread that has completed its download task.

In some embodiments, the segmentation process equally divided the target file into the plurality of segment files of the target file.

In some embodiments, a total number of the plurality of segment files of the target file is less or equal to a predetermined threshold; and the predetermined threshold is set by a user for limiting a number of the plurality of segment-download threads.

In some embodiments, the second starting module is further configured for: adding a new segment file record to a file downloading data table corresponding to the target file.

Other aspects of the present disclosure can be understood by those skilled in the art in light of the description, the claims, and the drawings of the present disclosure.

### BRIEF DESCRIPTION OF THE DRAWINGS

Various objectives, features, and advantages of the present disclosure can be more fully appreciated with reference to the detailed description of the present disclosure when considered in connection with the following drawings, in which like reference numerals identify like elements. It should be noted that the following drawings are merely examples for illustrative purposes according to various disclosed embodiments and are not intended to limit the scope of the present disclosure.

FIG. 1 illustrates a schematic hardware structural diagram of an exemplary terminal device in accordance with some embodiments of the present disclosure;

FIG. 2 illustrates a flowchart of an exemplary a file downloading method in accordance with some embodiments of the present disclosure;

FIG. 3 illustrates a flowchart of another exemplary a file downloading method in accordance with some other embodiments of the present disclosure;

FIG. 4 illustrates a schematic block structural diagram of an exemplary file downloading apparatus in accordance with some embodiments of the present disclosure; and

FIG. 5 illustrates a schematic block structural diagram of another exemplary file downloading apparatus in accordance with some other embodiments of the present disclosure.

### DETAILED DESCRIPTION

Reference input now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

In accordance with various embodiments, the present disclosure provides a file downloading method, a related apparatus, and a related terminal device.

Referring to FIG. 1, a schematic hardware structural diagram of an exemplary terminal device is shown in accordance with some embodiments of the present disclosure.

The disclosed file downloading method and apparatus can be applied to any suitable terminal device, such as a user terminal, or a server, etc. For example, the disclosed file downloading method and apparatus can be applied to the terminal device 100 illustrated in FIG. 1.

In some embodiments, the terminal device 100 can be a mobile terminal device, such as a smart phone, a tablet computer, an electronic book reader, a laptop portable computer, or a wearable mobile terminal, etc.

As shown in FIG. 1, the terminal device 100 can include a memory 102, memory controller 104, one or more hardware processor 106 (only one of which is shown in FIG. 1), a peripheral interface 108, a radio frequency module 110, an audio module 112, a touch screen 114, and any other appropriate components. These components can communicate with each other via one or more communication buses 116.

The memory 102 may be used to store software programs and modules, such as the program instructions/modules corresponding to the disclosed file downloading method and apparatus. The hardware processor 106 can implement the software programs and modules stored in the memory 102 to execute various functions and process data, such as the file downloading method provided by certain embodiments of the present disclosure.

The memory 102 may include high speed random access memory, and may also include non-volatile memory such as one or more magnetic storage devices, flash memory, or other non-volatile solid state memory. The accesses of the processor 106 and other possible components to the memory 102 may be performed under the control of the memory controller 104.

The peripheral interface 108 can be used to couple various input/output devices to the hardware processor 106 and the memory 102. In some embodiments, the peripheral interface 108, the hardware processor 106, and the memory controller 104 may be implemented in a single chip. In some other embodiments, the peripheral interface 108, the hardware processor 106, and the memory controller 184 may be implemented separately by separate chips.

The radio frequency module 110 can be used to receive and transmit electromagnetic waves, to effect mutual conversion of electromagnetic waves and electrical signals, and thereby to communicate with a communication network or other devices.

The audio module 112 can provide one or more audio interfaces, which may include one or more microphones, one or more speakers, and an audio circuit.

The touch screen 114 can provide an output and input interface between the terminal device 100 and a user at the same time. In particular, the touch screen 114 can display a video output to the user, the content of which may include text, graphics, video, and any combination thereof.

It should be understood that, the hardware structure shown in FIG. 1 is merely illustrative, and the terminal device 100 may also include more or fewer components than those shown in FIG. 1, or may have a configuration different from that shown in FIG. 1. The components shown in FIG. 1 may be implemented in hardware, software, or a combination thereof.

In some embodiments of the present disclosure, a client can be installed in the terminal device 100, and the client may be a browser or a third-party application software, and may provide a service to a user corresponding to a server. For example, the client can download files from the server to the terminal device 100.

In order to improve the downloading speed under a poor network condition or a low device performance condition, the present disclosure provides a file downloading method and a related apparatus. When multiple download threads are downloading multiple file segments of a target file, if one download thread has completed the current download task, the other download threads can be analyzed. One of the other download threads that has the largest sized un-downloaded content, or has a longest expected remaining download time can be identified. A portion of the un-downloaded content of the file segment corresponding to the identified download thread can be reallocated to the one download thread that has completed its current download task. The above process can be repeated until all the file segments are completely downloaded. Because the download threads that have completed their current download tasks can assist other download threads to do portions of the download tasks, the overall file downloading speed can be improved.

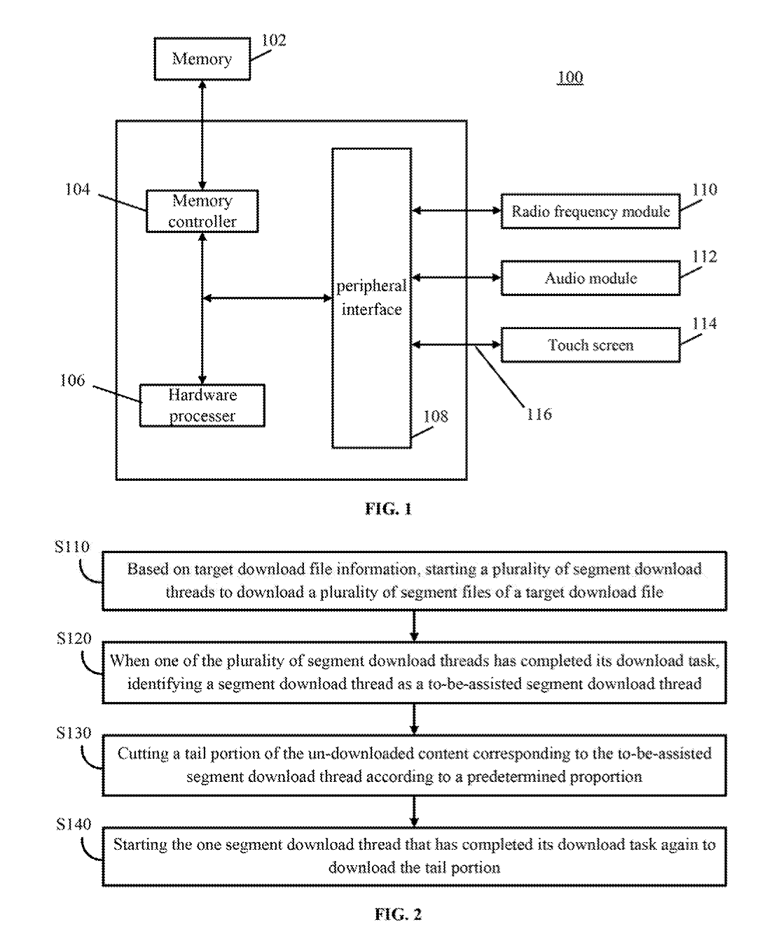

Referring to FIG. 2, a flowchart of an exemplary file downloading method is shown in accordance with some embodiments of the present disclosure. As illustrated, the file downloading method can include the following steps.

At step S110, based on information of a target file to be downloaded (or simply called a target file), multiple segment-download threads can be started to download multiple segment files of a target file. Each segment-download thread may download one or more file segments as a segment file. Each segment may have a same size or a different size, and/or a segment file may have a same number of or a different number of segments, based on specific applications.

In some embodiments, the information of the target file can identify the target file, so that the multiple segment-download threads can correctly identify the target file. The target file information can include size information, file header, file name, and any other suitable information of the target file. In order to improve the download speed, based on the target file information, multiple segment-download threads can be created to download the target file associated with the target file information.

At step S120, when one of the multiple segment-download threads has completed its download task, one of the other segment-download threads that has the largest sized un-downloaded content, or has a longest expected remaining download time can be identified and treated as a to-be-assisted segment-download thread.

A portion of the un-downloaded content of the one identified segment-download thread that has the largest sized un-downloaded content, or has the longest expected remaining download time can be downloaded by the segment-download thread that has completed its download task. As such, the un-downloaded content can be completely downloaded more quickly.

At step S130, a tail portion of the un-downloaded content corresponding to the to-be-assisted segment-download thread can be cut according to a predetermined proportion.

In some embodiments, the predetermined proportion may be determined based on a difference between the data amount of the un-downloaded content corresponding to the to-be-assisted segment-download thread and the data amount of the un-downloaded content corresponding to other segment-download threads. When the difference is small, the predetermined proportion may be relatively smaller. When the difference is large, the predetermined proportion may be relatively larger. A tail portion can be referred to a portion of the un-downloaded content that is farthest to the downloaded content determined based on the predetermined proportion and the up-downloaded content. Conversely, a head portion can be referred to a portion of the un-downloaded content that is nearest to the downloaded content determined based on the predetermined proportion and the un-downloaded content. In certain circumstances, the downloaded content may also be included to make the determination.

At step S140, the one segment-download thread that has completed its download task can be started again to download the tail portion.

The steps from S120 to S140 can be repeated until all of the multiple segment files are completely downloaded.

In some embodiments, the disclosed file downloading method can determine one segment-download thread that has the largest sized un-downloaded content, or has a longest expected remaining download time as a to-be-assisted segment-download thread, cut a tail portion of the un-downloaded content corresponding to the to-be-assisted segment-download thread according to a predetermined proportion, and start one segment-download thread that has completed its download task to download the tail portion. The above process can be repeated unit all segment files are completely downloaded. Since the segment-download threads that have completed their current download tasks can assist other segment download threads to do portions of the download tasks, the overall file downloading speed can be improved.

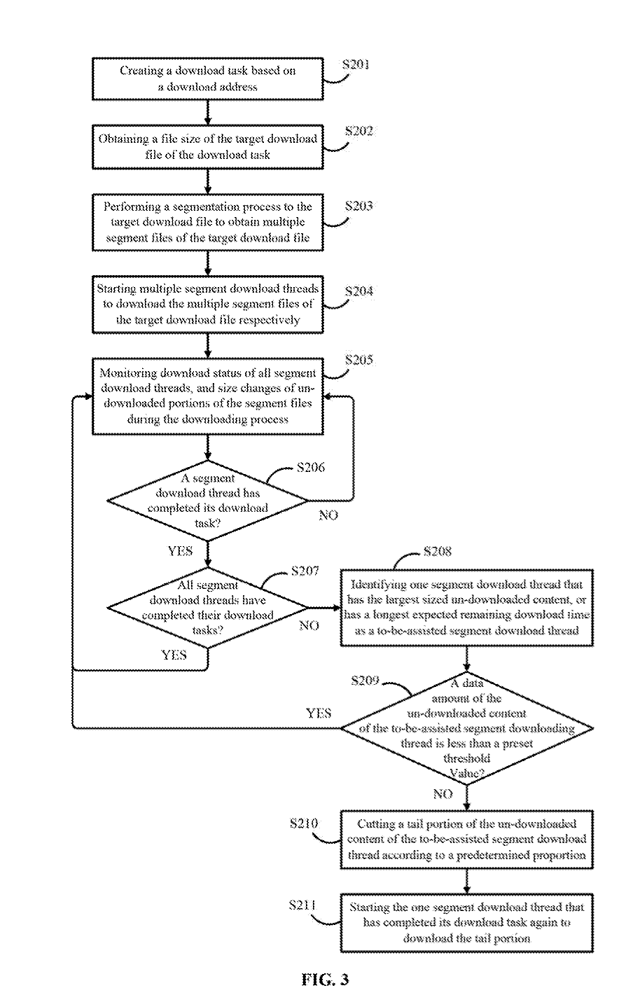

Referring to FIG. 3, a flowchart of another exemplary a file downloading method is shown in accordance with some other embodiments of the present disclosure. As illustrated, the method can include the following steps.

At step S201, a download task can be created based on a download address.

At step S202, a file size of the target file to be downloaded of the download task can be obtained.

A file download controller thread can be started to obtain the file size of the target file, and updates the file size information to a download file data table.

At step S203, a segmentation process can be performed to the target file to obtain multiple segment files of the target file.

The file download controller thread may divide the target file into multiple segment files by using a predetermined segmentation rule. A number of segment files may not exceed a preset threshold value. The preset threshold value may be used for restricting the number of download threads to be started, and may be a default value or may be set by a user. In some embodiments, the target file may be equally divided into multiple segment files. In some other embodiments, any other suitable segmentation rules may be employed.

At step S204, multiple segment-download threads can be started to download the multiple segment files of the target file respectively.

The file download controller thread can allocate a number of segment-download threads based on the number of the segment files, create a corresponding segment threads data table, and then start the multiple segment-download threads to download the segment files of the target file respectively.

At step S205, download status of all of the multiple segment-download threads, and size changes of un-downloaded portions of the segment files during the downloading process can be monitored.

The file download controller thread can continually monitor the download status of all segment-download threads and the size changes of the un-downloaded portions of the segment files of the target file, and can update the download file data table in real time.

During the downloading process, the multiple segment-download threads can notify the status change and the size change of the un-downloaded portions of the segment files to the file download controller thread. Accordingly, the corresponding download file data table and the segment threads data table can be updated.

At step S206, it can be determined whether a segment-download thread has completed its download task. If the determination result is a yes, step S207 can be performed, and the process can return to step S205.

During the downloading process, each segment-download thread can notify the status change and the size change of the un-downloaded portions of the segment files to the file download controller thread. The corresponding download file data table and the segment threads data table can be updated. Accordingly, the file download controller thread can determine whether a segment-download thread has completed its download task based on the notification.

At step S207, it can be determined whether all segment-download threads have completed their download tasks. If the determination result is a yes, the download process can be terminated. Otherwise, step S208 can be performed.

At step S208 one of the multiple segment-download threads that has the largest sized un-downloaded content, or has a longest expected remaining download time can be identified and treated as a to-be-assisted segment-download thread.

When a segmented download thread completes its segment download task, the download controller thread can receive a download completion status notification from the segment-download thread. Then the download controller thread can look for one of the multiple segment-download threads that has the largest sized un-downloaded content, or has a longest expected remaining download time.

At step S209, it can be determined whether a data amount of the un-downloaded content corresponding to the to-be-assisted segment-download thread is less than a preset threshold value. If a determination result is a yes, the process can return to step S205. Otherwise, step S210 can be performed.

At step S210, a tail portion of the cut-downloaded content corresponding to the to-be-assisted segment-download thread can be cut according to a predetermined proportion.

In some embodiments, if the data amount of the un-downloaded content corresponding to the to-be-assisted segment-download thread is less than the preset threshold value, the un-downloaded content corresponding to the to-be-assisted segment-downloaded thread may not be divided. It can be waited unit the un-downloaded content is completely downloaded by the to-be-assisted segment-download thread. Otherwise, the un-downloaded content can be divided into a head portion and a tail portion by a dichotomy method. A tail portion of the un-downloaded content can be assigned to the segment-download thread that has completed its download task. In addition, a new segment down load file record can be added to the segment threads data table, and the segment download file record of the segment download tread corresponding to the un-downloaded content can be updated.

In step S211, the segment-download thread that has completed its download task can be started again to download the tail portion.

When the download controller thread determined that all of the segment-download threads have a download completion status, the downloading task of the target file is completed.

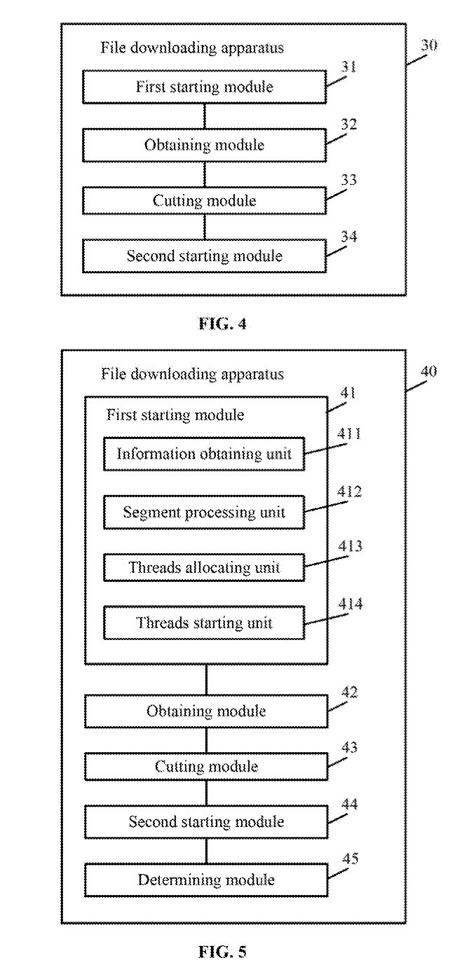

Referring to FIG. 4, a schematic block structural diagram of an exemplary file downloading apparatus is shown in accordance with some embodiments of the present disclosure. The disclosed file downloading apparatus can be operated in a terminal device described above in connection with FIG. 1.

As shown in FIG. 4, the file downloading apparatus 30 can include a first starting module 31, an obtaining module 32, a cutting module 33, and a second starting module 34.

The first starting module 31 can be used for starting multiple segment-download threads to download multiple segment files of a target file based on target file information.

The obtaining module 32 can be used for, when one of the multiple segment-download threads has completed its download task, identifying one of the other segment-download threads that has the largest sized un-downloaded content, or has a longest expected remaining download time as a to-be-assisted segment-download thread.

The cutting module 33 can be used for cutting a tail portion of the un-downloaded content corresponding to the to-be-assisted segment-download thread according to a predetermined proportion.

The second starting module 34 can be used for starting the one segment-download thread that has completed its download task again to download the tail portion.

The modules/units in some embodiments described above in connection with FIG. 4 may be implemented by software programs. And the above-described modules/units may be stored in the memory 102 of the terminal device 100 described above in connection with FIG. 1. In some other embodiments, the modules/units may be implemented by hardware such as integrated circuit chips.

Referring to FIG. 5, a schematic block structural diagram of another exemplary file downloading apparatus is shown in accordance with some other embodiments of the present disclosure. The disclosed file downloading apparatus can be operated in a terminal device described above in connection with FIG. 1.

As shown in FIG. 5, the file downloading apparatus 40 can include a first starting module 41, an obtaining module 42, a cutting module 43, a second starting module 44, and a determining module 45.

The first starting module 41 can be used for starting multiple segment-download threads to download multiple segment files of a target file based on target file information.

The obtaining module 42 can be used for, when one of the multiple segment-download threads has completed its download task, identifying one of the other segment-download threads that has the largest sized un-downloaded content, or has a longest expected remaining download time as a to-be-assisted segment-download thread.

The cutting module 43 can be used for cutting a tail portion of the un-downloaded content corresponding to the to-be-assisted segment-download thread according to a predetermined proportion.

The second starting module 44 can be used for starting the one segment-download thread that has completed its download task again to download the tail portion.

In some embodiments, the first starting module 41 can include an information obtaining unit 411, a segment processing unit 412, a threads allocating unit 413, and a threads starting unit 414.

The information obtaining unit 411 can be used for obtaining a file size of the target file based on target file information.

The segment processing unit 412 can be used for performing a segmentation process to the target file to obtain multiple segment files of the target file.

The threads allocating unit 413 can be used for allocating a number of segment-download threads based on a number of the segment files.

The threads starting unit 414 can be used for starting the multiple segment-download threads to download the multiple segment files of the target file respectively.

In some embodiments, the file downloading apparatus 40 can further include a determining module 45 used for determining whether a data amount of the un-downloaded content corresponding to the to-be-assisted segment-download thread is less than a preset threshold value. If a determination result is a yes, the un-downloaded content may be directly downloaded by the to-be-assisted segment-download thread. Otherwise, a tail portion of the un-downloaded content corresponding to the to-be-assisted segment-download thread can be cut according to a predetermined proportion.

Further, the obtaining module 42 may also be used for monitoring the download status of all of the multiple segment-download threads and size changes of un-downloaded portions of the segment files during the downloading process, and for determining whether a segment-download thread has completed its download task. If it is determined that a segment-download thread has completed its download task, the obtaining module 42 may further be used for determining whether all segment-download threads have completed their download tasks.

Further, the cutting module 43 may also be used for cutting the un-downloaded content corresponding to the to-be-assisted segment-download thread into a head portion and a tail portion according to a predetermined proportion, and for assigning the tail portion of the un-downloaded content to the segment-download thread that has completed its download task.

The modules/units in some embodiments described above in connection with FIG. 5 may be implemented by software programs. And the above-described modules/units may be stored in the memory 102 of the terminal device 100 described above in connection with FIG. 1. In some other embodiments, the modules/units may be implemented by hardware such as integrated circuit chips.

Accordingly, the disclosed file downloading method and apparatus can determine one segment-download thread that has the largest sized un-downloaded content, or has a longest expected remaining download time as a to-be-assisted segment-download thread, cut a tail portion of the un-downloaded content corresponding to the to-be-assisted segment-download thread according to a predetermined proportion, and start one segment-download thread that has completed its download task to download the tail portion. The above process can be repeated unit all segment filed are completely downloaded. Since the download threads that have completed their current download tasks can assist other download threads to do portions of the download tasks, the overall file downloading speed can be improved.

It should be noted that, the various embodiments of the present disclosure are described in a progressive manner, with each embodiment focusing on the differences from other embodiments. The same portions and similar portions of the embodiments can be referred to each other.

In some embodiments, the file downloading apparatus and system provided by the present disclosure can have the same realization principle and technical effect as those of the foregoing embodiments described above. For the sake of simplicity, the embodiments of the file downloading apparatus and system can be referred to the corresponding embodiments of the file downloading method.

In addition, the flowcharts and block diagrams in the figures illustrate various embodiments of the disclosed method and system, as well as architectures, functions and operations that can be implemented by a computer program product. In this case, each block of the flowcharts or block diagrams may represent a module, a code segment, a portion of program code. Each module, each code segment, and each portion of program code can include one or more executable instructions for implementing predetermined logical functions. It should also be noted that, in some alternative implementations, the functions illustrated in the blocks be executed or performed in any order or sequence not limited to the order and sequence shown and described in the figures. For example, two consecutive blocks may actually be executed substantially simultaneously where appropriate or in parallel to reduce latency and processing times, or even be executed in a reverse order depending on the functionality involved in. It should also be noted that, each block in the block diagrams and/or flowcharts, as well as they combinations of the blocks in the block diagrams and/or flowcharts, can be realized by a dedicated hardware-based system for executing specific functions, or can be realized by a dedicated system combined by hardware and computer instructions.

The disclosed subject matter provides a computer program product that includes computer-readable storage medium storing program codes. The program code includes instructions for performing the disclosed method. The specific implementations of the disclosed method can be referred to the various embodiments described above in connection with FIGS. 1-5.

Those skilled in the art can clearly understand that, for convenience and simplicity of description, the specific working process of the systems, devices and units described above can be referred to the corresponding processes of various embodiments of the disclosed method described above.

In various embodiments provided herein, it should be understood that, the disclosed system, apparatus and method can be realized through other ways. The disclosed embodiments of the apparatus are merely illustrative. For example, the division of units is merely a division of logical functions which may be divided by another way in the actual implementation. As another example, multiple units or components can be combined or be integrated into another system. Some features can be ignored, or not be executed. At another point, the illustrated or discussed mutual coupling, direct coupling, or communicating connection can be coupled or connected through electrical, mechanical, or other type of communication interfaces.

A unit described as a separate member may be or may not be physically separated. A component illustrated as a unit may be or may not be a physical unit. A unit can be located in one place, or be distributed to multiple network elements. According to actual needs, a part of or all of the units can be selected to realize the purpose of disclosed subject matter.

Further, various functional units in the various embodiments of the disclosed subject matter can be integrated in a processing unit, or can be separate physical units. Two or more functional units can also be integrated in one unit.

If the functions are implemented as software functional units, and being used or sold as a standalone product, the product can be stored in a computer readable storage medium. Based on this understanding, an essential part of the technical nature of the disclosed subject matter, or a part of the technical nature of the disclosed subject matter that can contribute to prior arts, or any part of the technical nature of the disclosed subject matter, can be embodied in a form of a computer software product. The computer software product can be stored in a storage medium, including multiple instructions to instruct a computer device (may be a personal computer, a server, or a network equipment) to perform all or part of the steps of the disclosed method according to various embodiments. The aforementioned storage media can include: U disk, removable hard disk, read only memory (ROM), random access memory (RAM), floppy disk, CD-ROM, or any other suitable medium that can store program codes.

It should be noted that, as used herein, relational terms such as “first,” “second,” and the like are used solely to a separate one operation/entity and another operation/entity, and do not necessarily require or imply that these entities or operations have actual relationship or order. Moreover, the term “comprising,” “including,” or any other variation thereof are intended to cover a non-exclusive inclusion, such that a process, a method, an article, or an apparatus, including a series of elements, does not only include those elements, but also include other non-explicitly listed elements, or further include some inherent elements of such process, method, article or apparatus. Without further constraints, an element defined by the clause “include a . . . ” does not exclude another same element in such process, method, article or apparatus.

Although the disclosed subject matter has been described and illustrated in the foregoing illustrative embodiments, it is understood that the present disclosure has been made only by way of example, and that numerous changes in the details of embodiment of the disclosed subject matter can be made without departing from the spirit and scope of the disclosed subject matter, which is only limited by the claims which follow. Features of the disclosed embodiments can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure. It should be noted that, similar reference numerals and letters are refer to similar items in the figures, and thus once an item is defined in one figure, it can be no further defined and explained in the subsequent figures.

What is claimed is:

1. A method for downloading files, comprising:
based on target file information of a target file, starting a plurality of segment-download threads to download a plurality of segment files of the target file;
when one of the plurality of segment-download threads has completed its download task, identifying a segment-download thread as a to-be-assisted segment-download thread, which still has un-downloaded content;
cutting a tail portion of the un-downloaded content corresponding to the to-be-assisted segment-download thread according to a predetermined proportion; and
starting the one segment-download thread that has completed its download task again to download the tail portion of the un-downloaded content corresponding to the to-be-assisted segment-download thread.

2. The method of claim 1, wherein:
the to-be-assisted segment-download thread is identified as one of the plurality of segment-download threads that has a largest sized on downloaded content.

3. The method of claim 1, wherein:
the to-be-assisted segment-download thread is identified as one of the plurality of segment-download threads that has a longest expected remaining download time.

4. The method of claim 1, wherein based on target file information of the target file, starting the plurality of segment-download threads to download the plurality of segment files of the target file includes:
obtaining a file size of the target file based on the target file information;
performing a segmentation process to the target file to obtain the plurality of segment files of the target file;
allocating the plurality of segment-download threads based on a total number of the plurality of segment files; and
starting the plurality of segment-download threads to download the plurality of segment files of the target file respectively.

5. The method of claim 1, before cutting the tail portion of the un-downloaded content, further comprising:
determining whether a data amount of the un-downloaded content corresponding to the to-be-assisted segment-download thread is less than a preset threshold value;
when it is determined that the data amount of the un-downloaded content is less than the preset threshold value, using the to-be-assisted segment-download thread to directly download the un-downloaded content; and
when it is determined that the data amount of the un-downloaded content is not less than the preset threshold value, cutting the tail portion of the un-downloaded content corresponding to the to-be-assisted segment-download thread according to the predetermined proportion.

6. The method of claim 1, further comprising:
monitoring download status of the plurality of segment-download threads and size changes of un-downloaded portions of the plurality of segment files during downloading process;
determining whether a segment-download thread has completed its download task;
when it is determined that one segment-download thread has completed its download task, determining whether all segment-download threads have completed their download tasks;
when it is determined that not all segment-download threads have completed their download tasks, identifying one segment-download thread as the to-be-assisted segment-download thread; and
when it is determined that that no segment-download thread has completed its download task, continually monitoring the download status of the plurality of segment-download threads and the size changes of un-downloaded portions of the plurality of segment files during downloading process.

7. The method of claim 1, wherein cutting the tail portion of the un-downloaded content corresponding to the to-be-assisted segment-download thread according to the predetermined proportion includes:
cutting the un-downloaded content corresponding to the to-be-assisted segment-download thread into a head portion and the tail portion according to a dichotomy method; and
assigning the tail portion of the un-downloaded content to the segment-download thread that has completed its download task.

8. The method of claim 4, wherein:
the segmentation process equally divided the target file into the plurality of segment files of the target file.

9. The method of claim 4, wherein:
a total number of the plurality of segment files of the target file is less or equal to a predetermined threshold; and
the predetermined threshold is set by a user for limiting a number of the plurality of segment-download threads.

10. The method of claim 4, after cutting the tail portion of the un-downloaded content, further comprising:
adding a new segment file record to a file downloading data table corresponding to the target file.

11. An apparatus for downloading files, comprising:
a first starting module configured for, based on target file information, starting a plurality of segment-download threads to download a plurality of segment files of a target file;
an obtaining module configured for, when one of the plurality of segment-download threads has completed its download task, identifying a segment-download thread as a to-be-assisted segment-download thread, which still has un-downloaded content;
a cutting module configured for cutting a tail portion of the un-downloaded content corresponding to the to-be-assisted segment-download thread according to a predetermined proportion; and
a second starting module configured for starting the one segment-download thread that has completed its download task again to download the tail portion of the un-downloaded content corresponding to the to-be-assisted segment-download thread.

12. The apparatus of claim 11, wherein:
the to-be-assisted segment-download thread is identified as one of plurality of segment-download threads that has a largest sized un-downloaded content.

13. The apparatus of claim 11, wherein:
the to-be-assisted segment-download thread is identified as one of plurality segment-download threads that has a longest expected remaining download time.

14. The apparatus of claim 11, wherein the first starting module includes:
an information obtaining unit configured for obtaining a file size of the target file based on the target file information;
a segmentation processing unit configured for performing a segmentation process to the target file to obtain the plurality of segment files of the target file;
a threads allocating unit configured for allocating the plurality of segment-download threads based on a number of the plurality of segment files; and
a threads staring unit configured for starting the plurality of segment-download threads to do unload the plurality of segment files of the target file respectively.

15. The apparatus of claim 11, further comprising:
determining module configured for:
determining whether a data amount of the un-downloaded content corresponding to the to-be-assisted segment-download thread is less than a preset threshold value,
when it is determined that the data amount of the un-downloaded content is less than the preset threshold value, controlling the to-be-assisted segment-download thread to directly download the un-downloaded content, and
when it is determined that the data amount of the un-downloaded content is not less than the preset threshold value, controlling the cutting module to cut the tail portion of the un-downloaded content corresponding to the to-be-assisted segment-download thread according to the predetermined proportion.

16. The apparatus of claim 11, wherein the obtaining module is further configured for:
monitoring download status of the plurality of segment-download threads and size changes of un-downloaded portions of the plurality of segment files during downloading process;
determining whether a segment-download thread has completed its download task;
when it is determined that one segment-download thread has completed its download task, determining whether all segment-download threads have completed their download tasks;
when it is determined that not all segment-download threads have completed their download tasks, identifying one segment-download thread as the to-be-assisted segment-download thread; and
when it is determined that no segment-download thread has completed its download task, continually monitoring the download status of the plurality of segment-download threads and the size changes of un-downloaded portions of the plurality of segment files during downloading process.

17. The apparatus of claim 11, wherein the cutting module is further configured for:
cutting the un-downloaded content corresponding to the to-be-assisted segment-download thread into a head portion and the tail portion according to a dichotomy method; and
assigning the tail portion of the un-downloaded content to the segment-download thread that has completed its download task.

18. The apparatus of claim 14, wherein:
the segmentation process equally divided the target file into the plurality of segment files of the target file.

19. The apparatus of claim 14, wherein:
a total number of the plurality of segment files of the target file is less or equal to a predetermined threshold; and
the predetermined threshold is set by a user for limiting a number of the plurality of segment-download threads.

20. The apparatus of claim 14, wherein the second starting module is further configured for:
adding a new segment file record to a file downloading data table corresponding to the target file.
